(19) United States
(12) Patent Application Publication
(10) Pub. No.: US 2008/0160823 A1
(43) Pub. Date: Jul. 3, 2008

(54) Electrical multipoint connector

(76) Inventors: Reinhold Jocham, Hechingen (DE); Christian Rother, Reutlingen (DE)

Correspondence Address: KENYON & KENYON LLP, ONE BROADWAY, NEW YORK, NY, 10004, US

(21) Appl. No.: 12/002,541

(22) Filed: Dec. 17, 2007

(30) Foreign Application Priority Data
Dec. 27, 2006 (DE) 102006062313.4

(51) Int. Cl. H01R 4/26

(52) U.S. Cl. 439/404

(57) ABSTRACT

In an electrical multipoint connector having a plurality of parallel plug pins and having terminal contacts for each of the plug pins, the plug pins and the terminal contacts are joined to each other by rigid conductor tracks running in parallel side-by-side, and in each case having a lateral outward bending.

### BACKGROUND INFORMATION

In present control-unit designs, electrical multipoint connectors (male multipoint connectors) are integrated as rigidly as possible into their plug-connector housing and coupled to a circuit substrate. This connection between the circuit substrate and the plug pins of the male multipoint connector is subject to vibrational stress, and given high vibrations as occur in the case of engine mounting, is controllable only with additional expenditure such as, for example, by damper elements.

Typical of present male multipoint connectors having a plastic coating, it is not possible to extrusion-coat the plug pins so imperviously with plastic that no moisture is able to penetrate along the plug pins when the wiring-harness plug connector is unassembled. However, automobile manufacturers require leakproof male multipoint connectors to ensure that control units which are in operation with leaky or damaged wiring harnesses are not damaged by water penetration.

### SUMMARY OF THE INVENTION

In the electrical multipoint connector according to the present invention, between the contacting to the circuit substrate and the contacting to the plug pin, thus between the terminal side and the plug side, rigid conductor tracks are provided with outward bendings in order to dampen the terminal side with respect to the plug side. Due to these outward bendings, for example, a vibrational stress on the plug side is only transferred in dampened fashion to the terminal side, which therefore stands up to high vibrational stresses, as well. Preferably, the rigid conductor tracks are produced from a thin punched grid, connecting webs between the individual grid conductor tracks being separated after a plastic coating has been applied to the grid conductor tracks. Interference-suppression capacitors may be integrated advantageously into the thin punched grid, as well. The electrical multipoint connector may be implemented on the terminal side using bondable or solderable interconnection technology for the connection to the circuit substrate; in the latter case, the electrical multipoint connector may take the form of an SMD component. The plug pins are preferably press-fitted and laser-welded into the thin punched grid. This measure makes it possible to weld in different pins, which means costs for tools can be saved when working with different plug variants. The plug pins may be additionally sealed against moisture by silicone encapsulating material in the plug-connector housing.

### BRIEF DESCRIPTION OF THE DRAWINGS

FIG. 1 shows the electrical multipoint connector according to the present invention having a bondable terminal side.

FIGS. 2a and 2b show a plug-connector configuration having a plug-connector housing, a circuit substrate and the electrical multipoint connector from FIG. 1 in the still unassembled state (FIG. 2a) and in the finished assembled state (FIG. 2b).

FIG. 3 shows the electrical multipoint connector according to the present invention having a solderable terminal side.

FIGS. 4a and 4b show a plug-connector configuration having a plug-connector housing, a circuit substrate and the electrical multipoint connector from FIG. 3 in the still unassembled state (FIG. 4a) and in the finished assembled state (FIG. 4b).

### DETAILED DESCRIPTION

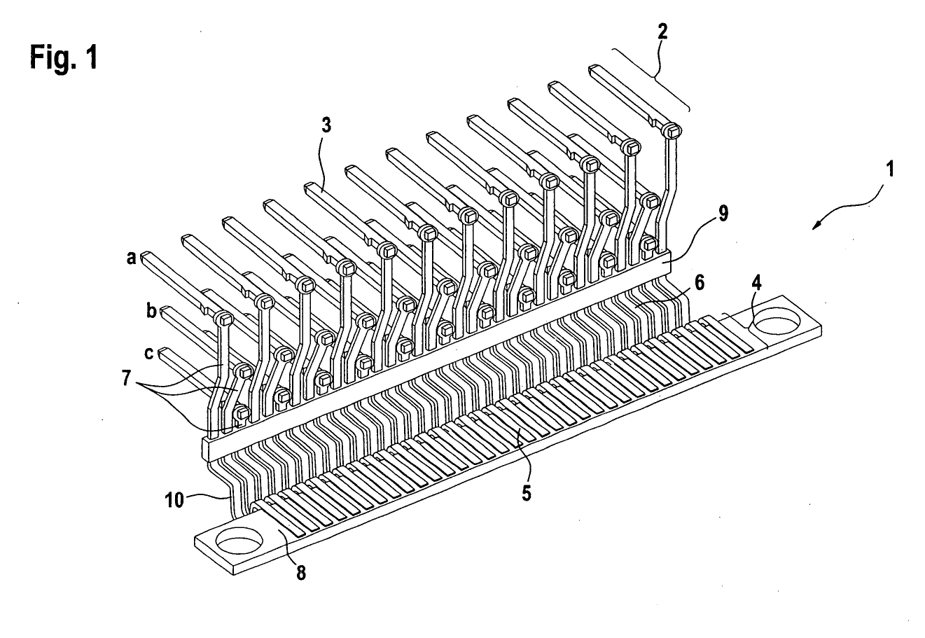

Electrical multipoint connector 1 shown in FIG. 1 has a plug-connector side 2 having parallel plug pins 3, which are disposed in three parallel rows a, b, c, and a terminal side 4 having terminal contacts 5 for each plug pin 3.

Terminal contacts 5 are formed by the ends of rigid conductor tracks 6 running in parallel side-by-side, at the other bent ends 7 of which, plug pins 3 are pressed in and laser-welded. On the terminal side, conductor tracks 6 are embedded into a transversely-running mounting bar 8 made of plastic, and are thereby joined mechanically to each other. Terminal contacts 5 are formed on mounting bar 8 by contact areas (bonding areas) of conductor tracks 6 exposed on the upper side. Bent ends 7 of conductor tracks 6 are likewise mechanically joined to each other by a crossbar 9 made of plastic. Between the two bars 8, 9, all conductor tracks 6 in each instance have an arched outward bending 10. These outward bendings 10 are all provided on the same side of the area defined by parallel conductor tracks 6, and are side-by-side in parallel. In the exemplary embodiment, ends 7 are bent by 90° compared to terminal-side conductor tracks 6, and plug pins 3 are pressed in at right angles at ends 7, so that plug pins 3 and terminal-side conductor tracks 6 extend in the same direction.

Rigid conductor tracks 6 may be produced from a thin copper punched grid having connecting webs between the individual grid conductor tracks. Outward bendings 10 are bent out from the punched-grid plane. After bars 8, 9 are produced by plastic claddings/coatings on this punched grid, the connecting webs are separated again.

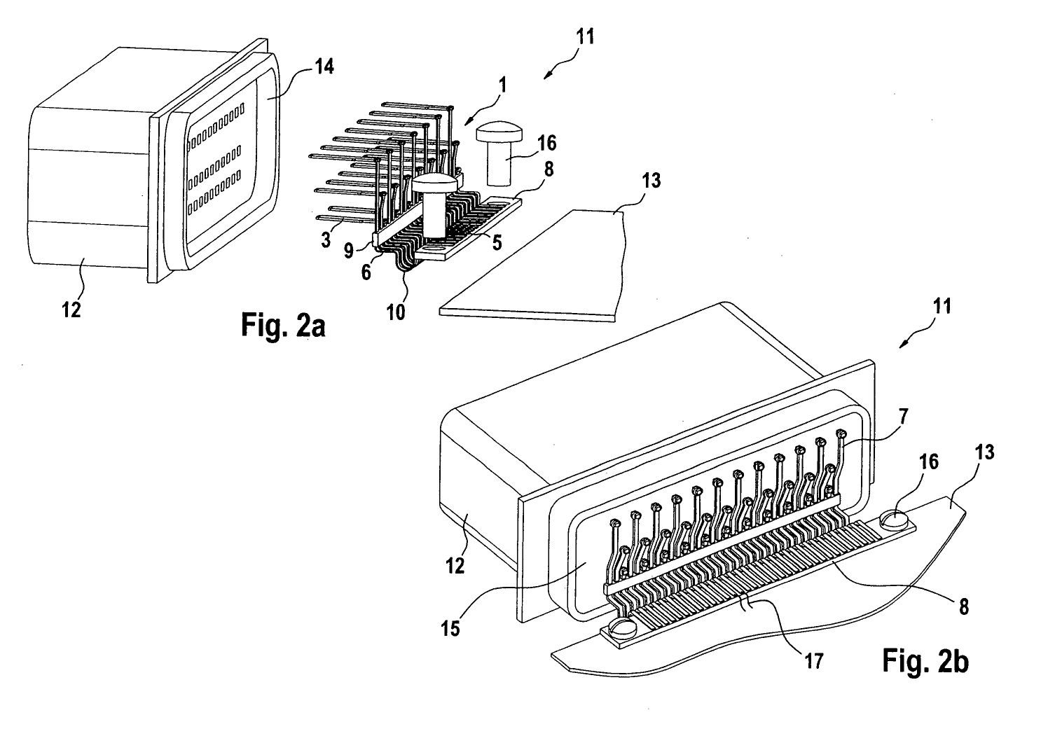

FIG. 2a shows a plug-connector configuration 11 having a plug-connector housing 12 for plug pins 3, a circuit substrate 13 and electrical multipoint connector 1 in the still unassembled state, and FIG. 2b shows plug-connector configuration 11 in the finished assembled state. In this finished assembled state, on one hand, plug pins 3 are pressed into plug-connector housing 12 and are sealingly encapsulated by an encapsulating material 15 in a rear encapsulating well 14 of plug-connector housing 12, and on the other hand, mounting bar 8 is secured on circuit substrate 13 by screws 16, and terminal contacts (bonding areas) 5 are each electrically connected to circuit substrate 13 by bonding wires 17.

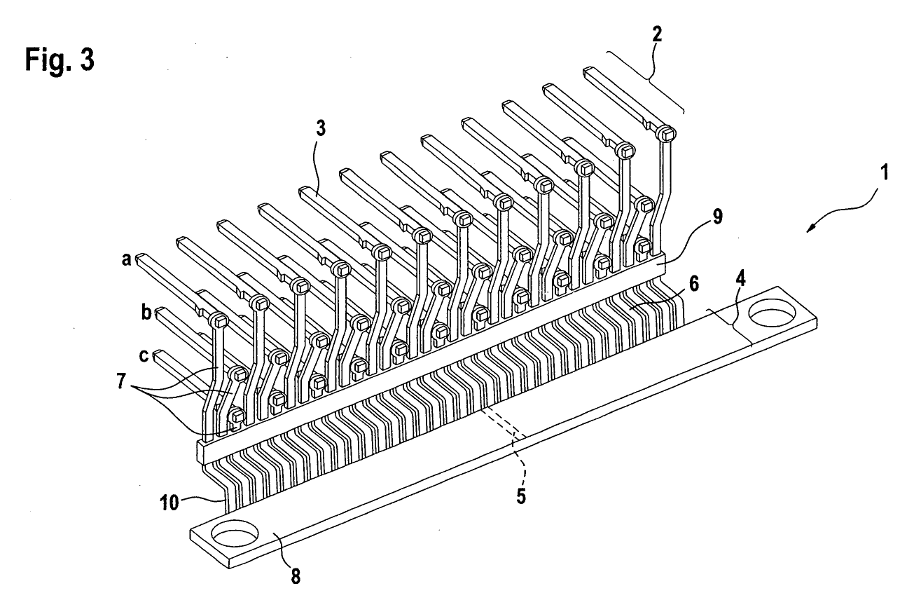

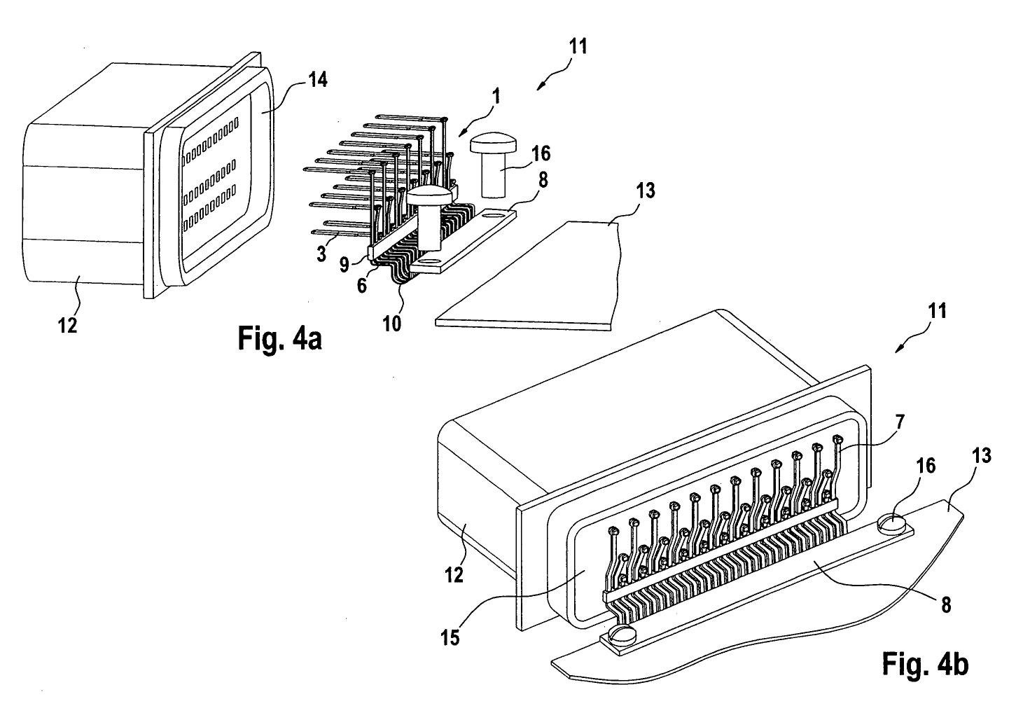

Multipoint connector 1 and plug-connector configuration 11 shown in FIGS. 3 and 4 differ from the multipoint connector and plug-connector configuration in FIGS. 1 and 2 only in that here, terminal contacts 5 are not provided as bonding areas on the upper side, but rather as SMD surfaces on the lower side, which are soldered or stuck onto circuit substrate 13.

Outward bendings 10 relieve strain between plug-connector side 2 and terminal side 4. Because of outward bendings 10, a vibrational stress on the plug-connector side is only transferred in dampened fashion to terminal side 4, which therefore stands up to high vibrational stresses, as well.

What is claimed is:

1. An electrical multipoint connector comprising:
a plurality of parallel plug pins;
a plurality of terminal contacts corresponding to the plurality of plug pins; and
rigid conductor tracks joining the plug pins and the terminal contacts to each other, the rigid conductor tracks running in parallel side-by-side, each of the rigid conductor tracks having a lateral outward bending.

2. The electrical multipoint connector according to claim 1, wherein the outward bendings are arched or in a meander form.

3. The electrical multipoint connector according to claim 1, wherein the outward bendings are formed in parallel side-by-side.

4. The electrical multipoint connector according to claim 1, wherein all of the outward bendings are situated on the same side of an area defined by the parallel, side-by-side conductor tracks.

5. The electrical multipoint connector according to claim 1, wherein the plug pins and the conductor tracks on a terminal side extend in the same direction.

6. The electrical multipoint connector according to claim 1, further comprising a bar mechanically joining the parallel, side-by-side conductor tracks in each case to each other on one or both sides of their outward bendings.

7. The electrical multipoint connector according to claim 1, wherein the terminal contacts are formed by ends of the parallel, side-by-side conductor tracks.

8. The electrical multipoint connector according to claim 1, wherein the terminal contacts have one of (a) solder surfaces and (b) bonding areas.

9. The electrical multipoint connector according to claim 1, wherein the plug pins are welded into ends of the parallel, side-by-side conductor tracks.

10. The electrical multipoint connector according to claim 1, further comprising a plug-connector housing, and wherein the plug pins are pressed into the plug-connector housing, and are sealingly encapsulated in a rear-side encapsulating well of the plug-connector housing.
